(19) United States
(12) Patent Application Publication
(10) Pub. No.: US 2023/0312950 A1
(43) Pub. Date: Oct. 5, 2023

(54) THREE-DIMENSIONAL PRINTING

(71) Applicant: Hewlett-Packard Development Company, L.P., Spring, TX (US)

(72) Inventors: STEPHEN G RUDISILL, SAN DIEGO, CA (US); KRZYSZTOF NAUKA, PALO ALTO, CA (US); EMRE HIRO DISCEKICI, SAN DIEGO, CA (US)

(73) Assignee: Hewlett-Packard Development Company, L.P., Spring, TX (US)

(21) Appl. No.: 18/013,156

(22) PCT Filed: Jul. 29, 2020
(86) PCT No.: PCT/US2020/043990

§ 371 Date: Dec. 27, 2022

(51) Int. Cl. C09D 11/101; C09D 11/102; C09D 177/06; B33Y 70/00; C09D 11/037

(52) U.S. Cl. CPC C09D 11/101; C09D 11/102; B29C 64/165; B33Y 70/00; C09D 11/037; C09D 177/06

(57) ABSTRACT

An example of an ultraviolet (UV) light fusing agent for three-dimensional (3D) printing includes a UV light absorber and a liquid vehicle. The UV light absorber consists of a fluorescent yellow dye. The liquid vehicle includes a surfactant, a co-solvent, and a balance of water. The UV light fusing agent is devoid of a saccharide.

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial curing, thermal merging/fusing, melting, sintering, etc. of the build material, and the mechanism for material coalescence may depend upon the type of build material used.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram depicting an example of a method for making a UV light fusing agent having a wavelength of maximum absorption targeted for a 3D printing system;

FIG. 2 is a flow diagram depicting an example of a method 3D printing method;

FIG. 3 is a schematic illustration of one example of the 3D printing method of FIG. 2;

FIG. 4 is a graph depicting the absorbance (Y axis, arbitrary units (A. U.), relative) versus wavelength (X-axis, nanometers (nm)) for two comparative formulations with azo dyes and two example UV light fusing agents;

FIGS. 5A through 5D are black and white reproductions of originally colored photographs of, respectively, example 3D objects formed with a low loading of an example UV light fusing agent and different power densities of a UV 395 nm light source; and

FIGS. 6A through 6D are black and white reproductions of originally colored photographs of, respectively, example 3D objects formed with a high loading of an example UV light fusing agent and different power densities of a UV 395 nm light source.

### DETAILED DESCRIPTION

Some three-dimensional (3D) printing methods utilize a fusing agent, which includes an energy absorber, to pattern polymeric build material. In these examples, an entire layer of the polymeric build material is exposed to electromagnetic radiation, but the patterned region (which, in some instances, is less than the entire layer) of the polymeric build material is fused/coalesced and hardened to become a layer of a 3D part. In the patterned region, the fusing agent is capable of at least partially penetrating into voids between the polymeric build material particles, and is also capable of spreading onto the exterior surface of the polymeric build material particles. The energy absorber in the fusing agent is capable of absorbing radiation and converting the absorbed radiation to thermal energy, which in turn fuses/coalesces the polymeric build material that is in contact with the fusing agent. Fusing/coalescing causes the polymeric build material to join or blend to form a single entity (i.e., the layer of the 3D part). Fusing/coalescing may involve at least partial thermal merging, melting, binding, and/or some other mechanism that coalesces the polymeric build material to form the layer of the 3D part.

In this type of 3D printing method, infrared (IR) and/or visible radiation is/are often used. These types of radiation can be emitted using incandescent lamps (blackbody emitters) that have a wide band of photon energies. This may create selectivity issues, because the incandescent lamps emit a great deal of near infrared (NIR) and IR radiation that non-patterned polymeric build material can absorb. This can lead to inaccurate parts shapes and/or rough part edges.

Narrow-band emission sources, such as UV light emitting diodes (LED) may be a suitable alternative for these 3D print systems. A fusing agent is disclosed herein that is formulated with a fluorescent yellow dye having a targeted wavelength of maximum absorption for the 3D print system including the narrow UV-band emission source. The fluorescent yellow dye is a narrow UV wavelength band energy absorber, which is known to be efficient in converting the absorbed light into transmitted light. The present inventors have surprisingly found that the fluorescent yellow dyes disclosed herein are also efficient in converting the absorbed light into enough thermal energy to coalesce polymeric build material in contact therewith. Some of the fluorescent yellow dyes disclosed herein also exhibit a pH-switchable spectrum, which enables the fusing agent to be formulated for a specific narrow UV-band emission source.

Throughout this disclosure, a weight percentage that is referred to as “wt % active” refers to the loading of an active component of a dispersion or other formulation that is present, e.g., in the fusing agent, detailing agent, etc. For example, a surfactant may be present in a water-based formulation (e.g., stock solution or dispersion) before being incorporated into the fusing agent vehicle. In this example, the wt % actives of the surfactant accounts for the loading (as a weight percent) of the surfactant molecules that are present in the fusing agent, and does not account for the weight of the other components (e.g., water, etc.) that are present in the stock solution or dispersion with the surfactant molecules. The term “wt %,” without the term actives, refers to the loading (in the fusing agent, etc.) of a 100% active component that does not include other non-active components therein.

3D Printing Kits and 3D Printing Multi-Fluid Kits

The fusing agent disclosed herein may be included in a multi-fluid kit for 3D printing or a 3D printing kit.

An example of the multi-fluid kit for 3D printing may include an ultraviolet (UV) light fusing agent, including a UV light absorber consisting of a fluorescent yellow dye and a liquid vehicle including a surfactant, a co-solvent, and a balance of water; and a detailing agent. In some examples, the detailing agent includes a surfactant, a co-solvent, and a balance of water. In still other examples, the multi-fluid kit may include the fusing agent and a colored ink. In yet further examples, the multi-fluid kit may include the fusing agent, the detailing agent, and the colored ink.

An example of a 3D printing kit includes a polymeric build material composition; and an ultraviolet (UV) light fusing agent, including a UV light absorber consisting of a fluorescent yellow dye and a liquid vehicle including a surfactant, a co-solvent, and a balance of water. Some examples of the 3D printing kit also include a detailing agent including a surfactant, a co-solvent, and a balance of water, and/or a colored ink.

It is to be understood that the fluids of the multi-fluid kits or fluids and composition of the 3D printing kits may be maintained separately until used together in examples of the 3D printing method disclosed herein. The fluids and/or compositions may each be contained in one or more containers prior to and during printing, but may be combined together during printing. The containers can be any type of a vessel (e.g., a reservoir), box, or receptacle made of any material.

As used herein, it is to be understood that the terms “set” or “kit” may, in some instances, be synonymous with “composition.”

As mentioned, various fluids and/or composition(s) may be included in the fluid kits and/or 3D printing kits disclosed herein. Example compositions of the fusing agent, the detailing agent, the colored ink, and the build material composition will now be described.

Fusing Agent

The ultraviolet (UV) light fusing agent disclosed herein includes a UV light absorber consisting of a fluorescent yellow dye and a liquid vehicle including a surfactant, a co-solvent, and a balance of water, wherein the UV light fusing agent is devoid of a saccharide. Saccharides are often used in inks in order to improve lightfastness. Improved lightfastness is not desirable for the UV light fusing agent, and thus saccharides or other lightfastness additives are not included.

The UV light fusing agent includes a UV light absorber. The UV light absorber consists of the fluorescent yellow dye, without any other colorant. As such, the UV light fusing agent is devoid of another pigment or dye. In particular, it would not be desirable to include any pigment or dye that absorbs other light, or any pigment that could crash out of solution when included with the fluorescent yellow dye.

The fluorescent yellow dye may be pyranine:

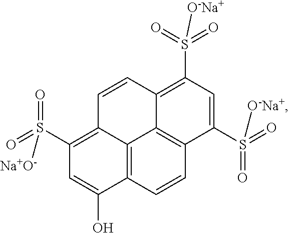

a pyranine derivative, coumarin:

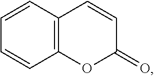 [SMILES: O=c1ccc2ccccc2o1]

a coumarin derivative, a naphthalimide:

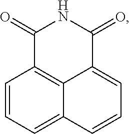 [SMILES: O=C1NC(=O)c2cccc3cccc1c23]

a naphthalimide derivative, a disazomethine derivative: RCH═N—N═CHR, or mixture of these compounds. Some specific examples include Solvent Green 7 (pyranine), Acid Yellow 184 (a coumarin derivative), Acid Yellow 250 (a coumarin derivative), Yellow 101 (Aldazine:

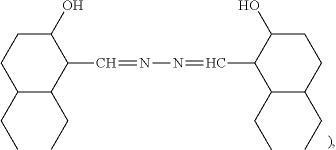 [SMILES: CCC1CCC(O)C(C=NN=CC2C(O)CCC(CC)C2CC)C1CC]

Basic Yellow 40 (a coumarin derivative), Solvent Yellow 43 (a naphthalimide derivative), Solvent Yellow 44 (a naphthalimide derivative), Solvent Yellow 85 (a naphthalimide derivative), Solvent Yellow 145 (a coumarin derivative), Solvent Yellow 160:1 (a coumarin derivative), and combinations thereof.

Some of the fluorescent yellow dyes also exhibit pH-switching absorbance behavior. With these dyes, the maximum absorption of the dye changes depending upon the pH. As examples, Solvent Green 7 (pyranine), coumarin derivatives with labile protons (e.g., Acid Yellow 184, Acid Yellow 250, and Solvent Yellow 145), and naphthalimide derivatives with labile protons (e.g., Solvent Yellow 43, Solvent Yellow 44, and Solvent Yellow 85) have pH-switching absorbance behavior. As such, the absorbance properties of these dyes can be tuned for one illumination wavelength or another by changing the pH of fusing agent liquid vehicle. For example, the maximum absorption of the coumarin or naphthalimide derivatives with labile protons may shift from about 30 nm to about 50 nm depending upon the pH. For another example, when the fluorescent yellow dye Solvent Green 7 and the pH of the fusing agent ranges from about 6 to about 7, Solvent Green 7 exhibits maximum absorption at a wavelength ranging of about 404 nm, and thus the wavelength of maximum absorption of the UV light fusing agent is about 404 nm. For yet another example, when the fluorescent yellow dye Solvent Green 7 and the pH of the fusing agent ranges from about 4 to about 5, Solvent Green 7 exhibits maximum absorption at a wavelength ranging of about 403 nm, and thus the wavelength of maximum absorption of the UV light fusing agent is about 403 nm. For still another example, when the fluorescent yellow dye is Solvent Green 7 and the pH of the fusing agent ranges from about 8 to about 9, Solvent Green 7 exhibits maximum absorption at a wavelength of about 455 nm, and thus the wavelength of maximum absorption of the UV light fusing agent is about 455 nm.

The UV light absorber, i.e., the fluorescent yellow dye, may be present in the fusing agent in an amount ranging from about 1 wt % active to about 10 wt % active, based on a total weight of the UV light fusing agent. In another example, the fluorescent yellow dye may be present in the fusing agent in an amount ranging from about 5 wt % active to about 8 wt % active, or from about 5.5 wt % active to about 7.5 wt % active.

In addition to the UV light absorber, the fusing agent also includes the liquid vehicle, which includes a surfactant, a co-solvent, and a balance of water. In some examples, the liquid vehicle may include other additives, such as antimicrobial agents, anti-kogation agents, humectants, etc.

Suitable surfactant(s) for the fusing agent include non-ionic or anionic. Some example surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. Some specific examples include a self-emulsifiable, non-ionic wetting agent based on acetylenic diol chemistry (e.g., SURFYNOL® SEF from Evonik Degussa), a non-ionic ethoxylated low-foam wetting agent (e.g., SURFYNOL® 440 or SURFYNOL® CT-111 from Evonik Degussa), a non-ionic ethoxylated wetting agent and molecular defoamer (e.g., SURFYNOL® 420 from Evonik Degussa), non-ionic wetting agents and molecular defoamers (e.g., SURFYNOL® 104E and SURFYNOL® 355 from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Examples of suitable anionic surfactants include sodium dodecyl sulfate, dioctyl sulfosuccinate, and alkyldiphenyloxide disulfonate (e.g., the DOWFAX™ series, such a 2A1, 3B2, 8390, C6L, C10L, and 30599, from The Dow Chemical Company).

Whether a single surfactant is used or a combination of surfactants is used, the total amount of surfactant(s) in the fusing agent may range from about 0.01 wt % active to about 3 wt % active based on the total weight of the fusing agent. In an example, the total amount of surfactant(s) in the fusing agent may be about 1.3 wt % active based on the total weight of the fusing agent.

The co-solvent in the fusing agent may be a water soluble or water miscible organic co-solvent. The water soluble or water miscible organic co-solvent in the fusing agent may include C2 to C10 alkylene diol, C3 to C10 alkylene triol, C3 to C10 alkylene glycol, or a mixture thereof. In an example, the organic co-solvent can be selected from 1,2-ethanediol, 1,2-propanediol, 1,3-propane diol, 2-methyl-1,3-propanediol, glycerol, propylene glycol, diethylene glycol, triethylene glycol, tetraethylene glycol, or a combination thereof. In yet another example, the organic co-solvent can include 1,2-ethanediol, 1,2-propanediol, 1,3-propane diol, 2-methyl-1,3-propanediol, glycerol, propylene glycol, diethylene glycol, triethylene glycol, tetraethylene glycol, dialcohols, trialcohols, polyalcohols, oligomeric glycol solvents, or a combination thereof. In a further example, the organic co-solvent can include propylene glycol. In still other example, amine or lactam organic co-solvents may also be used.

The amount of co-solvent in the fusing agent ranges from about 1 wt % to about 50 wt %, based on the total weight of the fusing agent. In other examples, the amount of co-solvent in the fusing agent may range from about 5 wt % to about 24 wt %, or from about 5 wt % to about 15 wt %, etc.

The balance of the fusing agent is water (e.g., deionized water, purified water, etc.). The amount of water may vary depending upon the amounts of the other components in the fusing agent. In one example, the fusing agent is jettable via a thermal inkjet printhead, and includes from about 50 wt % to about 90 wt % water.

The desired pH of the fusing agent may range from about 4 to about 10. When the fluorescent yellow dye and the liquid vehicle components are mixed together, the pH may be determined and adjusted to a desirable level.

If the fluorescent yellow dye is pH switchable and it is desirable for the fusing agent to be acidic, an acid may be added to lower the pH. Any suitable strong mineral acid, such hydrochloric acid, nitric acid, sulfuric acid, and phosphoric acid, may be used. Acetic acid may also be used. As such, examples of the fusing agent further include an acid. The amount of acid that is added will depend upon the pH of the initially prepared fusing agent, and will be enough to lower the pH to less than 7.

If the fluorescent yellow dye is pH switchable and it is desirable for the fusing agent to be basic, a base may be added to raise the pH. Any suitable base, such as potassium hydroxide (KOH), sodium hydroxide (NaOH), ammonium hydroxide (NH₄OH), triethanolamine (C6H₁₅NO₃), etc. may be used. As such, examples of the fusing agent further include a base. The amount of base that is added will depend upon the pH of the initially prepared fusing agent, and will be enough to increase the pH to at least 8.

One example of the fusing agent includes the UV light absorber present in an amount ranging from about 2 wt % active to about 10 wt % active, based on a total weight of the UV light fusing agent; the surfactant present in an amount ranging from about 0.5 wt % active to about 2 wt % active, based on the total weight of the UV light fusing agent; and the co-solvent present in an amount ranging from about 5 wt % active to about 20 wt % active, based on the total weight of the UV light fusing agent. The balance of this example fusing agent is water.

As mentioned herein, some examples of the fusing agent may include additional additives, such as such as antimicrobial agents, anti-kogation agents, humectants, etc.

In some examples, the fusing agent liquid vehicle may also include antimicrobial agent(s). Antimicrobial agents are also known as biocides and/or fungicides. Examples of suitable antimicrobial agents include the NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

In an example, the total amount of antimicrobial agent(s) in the fusing agent ranges from about 0.01 wt % active to about 0.05 wt % active (based on the total weight of the fusing agent). In another example, the total amount of antimicrobial agent(s) in the fusing agent is about 0.04 wt % active (based on the total weight of the fusing agent).

Examples of the fusing agent that are to be jetted using thermal inkjet printing may also include anti-kogation agent(s). Kogation refers to the deposit of dried printing liquid (e.g., fusing agent) on a heating element of a thermal inkjet printhead. Anti-kogation agent(s) is/are included to assist in preventing the buildup of kogation.

Examples of suitable anti-kogation agents include oleth-3-phosphate (commercially available as CRODAFOS™ O3A or CRODAFOS™ N-3A) or dextran 500 k. Other suitable examples of the anti-kogation agents include CRODAFOS™ HCE (phosphate-ester from Croda Int.), CRODAFOS® O10A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The anti-kogation agent may be present in the fusing agent in an amount ranging from about 0.1 wt % active to about 1.5 wt % active, based on the total weight of the fusing agent. In an example, the anti-kogation agent is present in an amount of about 0.5 wt % active, based on the total weight of the fusing agent.

The fusing agent vehicle may also include humectant(s). An example of a suitable humectant is ethoxylated glycerin having the following formula:

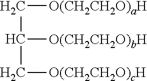

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the fusing agent ranges from about 3 wt % active to about 10 wt % active, based on the total weight of the fusing agent.

Detailing Agent

Some examples of the multi-fluid kit and/or 3D printing kit include a detailing agent. The detailing agent may include a surfactant, a co-solvent, and a balance of water. In some examples, the detailing agent consists of these components, and no other components. In some other examples, the detailing agent may further include additional components, such as anti-kogation agent(s) and/or antimicrobial agent(s) (each of which is described above in reference to the fusing agent).

The surfactant(s) that may be used in the detailing agent include any of the surfactants listed herein in reference to the fusing agent. The total amount of surfactant(s) in the detailing agent may range from about 0.10 wt % to about 5 wt % with respect to the total weight of the detailing agent.

The co-solvent(s) that may be used in the detailing agent include any of the co-solvents listed above in reference to the fusing agent. The total amount of co-solvent(s) in the detailing agent may range from about 1 wt % to about 65 wt % with respect to the total weight of the detailing agent.

In the examples disclosed herein, the detailing agent does not include a colorant. In these examples, the detailing agent may be colorless, meaning that the detailing agent is achromatic and is devoid of (i.e., does not include) a colorant.

The balance of the detailing agent is water. As such, the amount of water may vary depending upon the amounts of the other components that are included.

Colored Ink

In any of the examples of the multi-fluid kit, the 3D printing kit and/or the 3D printing method disclosed herein, a colored ink may be used.

The fusing agent disclosed herein generates parts that have a yellow tint. The colored ink may be selected to enhance the yellow color, or to mask the yellow color. A colored ink that is separate from the fusing agent may be desirable because the two agents can be applied separately, thus allowing control over the final part color or over the shade, hue, or intensity of the yellow. The colored ink may be applied during printing (e.g., on the polymeric build material with the fusing agent) or after printing (e.g., on a 3D printed object) to impart a colored appearance to the 3D printed object.

The colored ink may be a black agent, a cyan agent, a magenta agent, or a yellow agent. As such, the colorant may be a black colorant, a cyan colorant, a magenta colorant, a yellow colorant, or a combination of colorants that together achieve a black, cyan, magenta, or yellow color.

The colored ink may include the colorant, a co-solvent, and a balance of water. In some examples, the colored ink consists of these components, and no other components. In still other examples, the colored ink may further include additional components that aid in colorant dispersability and/or ink jettability. Some examples of additional ink components include dispersant(s) (e.g., a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins), humectant(s), surfactant(s), anti-kogation agent(s), and/or antimicrobial agent(s) (some of which is described herein in reference to the fusing agent).

The colorant of the colored ink may be any pigment or dye. When the colored ink is separate agent, the pigment or dye is to impart color, and is not meant to replace the UV light absorber in the fusing agent. As such, the colorant may function as a UV absorber or as a partial UV absorber, or may not provide any UV absorption.

An example of the pigment based colored ink may include from about 1 wt % to about 10 wt % of pigment(s), from about 10 wt % to about 30 wt % of co-solvent(s), from about 1 wt % to about 10 wt % of dispersant(s), 0.01 wt % to about 1 wt % of anti-kogation agent(s), from about 0.05 wt % to about 0.1 wt % antimicrobial agent(s), and a balance of water. An example of the dye based colored ink may include from about 1 wt % to about 7 wt % of dye(s), from about 10 wt % to about 30 wt % of co-solvent(s), from about 1 wt % to about 7 wt % of dispersant(s), from about 0.05 wt % to about 0.1 wt % antimicrobial agent(s), from 0.05 wt % to about 0.1 wt % of chelating agent(s), from about 0.005 wt % to about 0.2 wt % of buffer(s), and a balance of water.

Build Material Composition

The build material composition includes a polymeric build material. Examples of suitable polymeric materials include a polyamide (PAs) (e.g., PA 11/nylon 11, PA 12/nylon 12, PA 6/nylon 6, PA 8/nylon 8, PA 9/nylon 9, PA 66/nylon 66, PA 612/nylon 612, PA 812/nylon 812, PA 912/nylon 912, etc.), a polyolefin (e.g., polyethylene, polypropylene, etc.), a thermoplastic polyamide (TPA), a thermoplastic polyurethane (TPU), a styrenic block copolymer (TPS), a thermoplastic polyolefin elastomer (TPO), a thermoplastic vulcanizate (TPV), thermoplastic copolyester (TPC), a polyether block amide (PEBA), polyvinylidene fluoride (PVDF), or a combination thereof.

In some examples, the polymeric build material may be in the form of a powder. In other examples, the polymeric build material may be in the form of a powder-like material, which includes, for example, short fibers having a length that is greater than its width. In some examples, the powder or powder-like material may be formed from, or may include, short fibers that may, for example, have been cut into short lengths from long strands or threads of material.

The polymeric build material may be made up of similarly sized particles and/or differently sized particles. In an example, the average particle size of the polymeric build material ranges from about 2 μm to about 225 μm. In another example, the average particle size of the polymeric build material ranges from about 10 μm to about 130 μm. The term “average particle size”, as used herein, may refer to a number-weighted mean diameter or a volume-weighted mean diameter of a particle distribution.

When the polymeric build material is a crystalline or semi-crystalline material, the polymer may have a wide processing window of greater than 5° C., which can be defined by the temperature range between the melting point and the re-crystallization temperature. In an example, the polymer may have a melting point ranging from about 35° C. to about 300° C. As other examples, the polymer may have a melting point ranging from about 155° C. to about 225° C., from about 155° C. to about 215° C., about 160° C. to about 200° C., from about 170° C. to about 190° C., or from about 182° C. to about 189° C. As still another example, the polymer may be a polyamide having a melting point of about 180° C. or a polypropylene having a melting point of about 160° C.

Other polymers do not have a defined melting point, but rather have a range of temperatures over which the polymers soften. In some examples, this softening temperature range is from about 130° C. to about 250° C.

In some examples, the polymeric build material does not substantially absorb radiation having a wavelength within the range of 300 nm to 460 nm. The phrase “does not substantially absorb” means that the absorptivity of the polymeric build material at a particular wavelength is 25% or less (e.g., 20%, 10%, 5%, etc.).

In some examples, in addition to the polymeric build material, the build material composition may include an antioxidant, an antistatic agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polymeric build material and/or to further prevent or slow discoloration (e.g., yellowing) of the polymeric build material by preventing or slowing oxidation of the polymeric build material. In some examples, the antioxidant may be a radical scavenger. In these examples, the antioxidant may include IRGANOX® 1098 (benzenepropanamide, N,N-1,6-hexanediyIbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric build material. In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based upon the total weight of the build material composition.

Flow aid(s) may be added to improve the coating flowability of the build material composition. Flow aids may be particularly beneficial when the build material composition has an average particle size less than 25 μm. The flow aid improves the flowability of the build material composition by reducing the friction, the lateral drag, and the tribocharge buildup (by increasing the particle conductivity). Examples of suitable flow aids include tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in an amount ranging from greater than 0 wt % to less than 5 wt %, based upon the total weight of the build material composition.

Methods

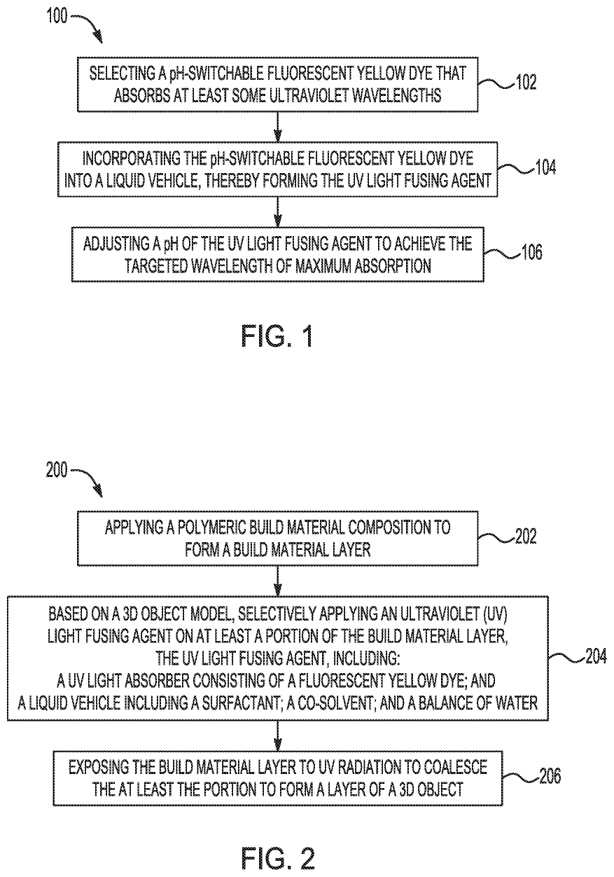

One example of a method disclosed herein is a method for making a UV light fusing agent having a wavelength of maximum absorption targeted for a 3D printing system. This example method 100 is shown in FIG. 1. The method 100 includes selecting a pH-switchable fluorescent yellow dye that absorbs at least some ultraviolet wavelengths (reference numeral 102); incorporating the pH-switchable fluorescent yellow dye into a liquid vehicle, thereby forming the UV light fusing agent (reference numeral 104); and adjusting a pH of the UV light fusing agent to achieve the targeted wavelength of maximum absorption (reference numeral 106).

Any of the pH-switchable fluorescent yellow dyes disclosed herein may be used in this example method 100. The dye may be particularly selected, and then the fusing agent particularly formulated, so that the wavelength of maximum absorption matches the narrow UV-band emission source of the printing system that is to be used. The spectrum of the narrow UV-band emission source may be characterized by its lambda maximum (λₘₐₓ, peak center) and FWHM (full width at half maximum). The wavelength of maximum absorption of the dye “matches” the narrow UV-band emission source as long as it falls within λₘₐₓ +/−⅔ of the FWHM. For example, if the narrow UV-band emission source emits at 395 nm, the fusing agent may be formulated so that the pH-switchable fluorescent yellow dye has a wavelength of maximum absorption ranging anywhere from 395 nm to about 410 nm. For another example, if the narrow UV-band emission source emits at 450 nm, the fusing agent may be formulated so that the pH-switchable fluorescent yellow dye has a wavelength of maximum absorption anywhere from 450 nm to about 475 nm.

In an example of the method 100, once the pH-switchable fluorescent yellow dye is selected, the liquid vehicle may be prepared. The liquid vehicle may be any of the examples disclosed herein. In an example, the liquid vehicle includes the surfactant, co-solvent, and water. In another example, the liquid vehicle includes the surfactant, co-solvent, water, and one or more of the other additives set forth herein for the fusing agent. The components of the liquid vehicle may be prepared and then mixed with the pH-switchable fluorescent yellow dye to generate an initial fusing agent.

The wavelength of maximum absorption of the pH-switchable fluorescent yellow dye can be tweaked through the pH of the initial fusing agent. As such, the pH of the initial fusing agent may be measured using any suitable pH measurement technique in order to determine whether the pH of the fusing agent, and thus the wavelength of maximum absorption of the pH-switchable fluorescent yellow dye, is suitable for the 3D printing system.

If the pH of the initial fusing agent is at a desirable level, and thus the wavelength of maximum absorption of the pH-switchable fluorescent yellow dye is at the targeted wavelength for the 3D print system, no additional adjustments are performed and the fusing agent may be used in the 3D printing system. As one example of this, the pH-switchable fluorescent yellow dye is Solvent Green 7 and the incorporation of the pH-switchable fluorescent yellow dye into the liquid vehicle adjusts the pH to within a range of from about 6 to about 7. The wavelength of maximum absorption of the Solvent Green 7 within this pH range is about 404 nm. For a 3D print system with a 395 nm narrow UV-band emission source, this fusing agent has a targeted wavelength of maximum absorption and thus no additional adjustment to the pH is made.

If the pH of the initial fusing agent is too low, and thus the wavelength of maximum absorption of the pH-switchable fluorescent yellow dye is not at the targeted wavelength for the 3D print system, a base may be added to the initial fusing agent. As one example of this, the pH-switchable fluorescent yellow dye is Solvent Green 7 and the incorporation of the pH-switchable fluorescent yellow dye into the liquid vehicle adjusts the pH of the initial fusing agent to within a range of from about 6 to about 7. As noted above, the wavelength of maximum absorption of the Solvent Green 7 within this pH range is about 404 nm. For a 3D print system with a 450 nm narrow UV-band emission source, this initial fusing agent has a targeted wavelength of maximum absorption that is too low. A base may be added to bring the pH within the range of from about 8 to about 9, which alters the targeted wavelength of maximum absorption of the dye to about 455 nm. Any of the bases described in reference to the fusing agent may be used.

If the pH of the initial fusing agent is too high, and thus the wavelength of maximum absorption of the pH-switchable fluorescent yellow dye is not at the targeted wavelength for the 3D print system, an acid may be added to the initial fusing agent. As one example of this, the pH-switchable fluorescent yellow dye is Solvent Green 7 and the incorporation of the pH-switchable fluorescent yellow dye into the liquid vehicle adjusts the pH to within a range of from about 6 to about 7. The wavelength of maximum absorption of the Solvent Green 7 within this pH range is about 404 nm. For a 3D print system with a 395 nm narrow UV-band emission source, it may be desirable to bring the wavelength of maximum absorption closer to the peak wavelength of the narrow UV-band emission source. An acid may be added to bring the pH within the range of from about 4 to about 5, which alters the targeted wavelength of maximum absorption of the dye to about 403 nm. Any of the acids described in reference to the fusing agent may be used.

Once the desirable pH and the targeted wavelength of maximum absorption of the dye are achieved, the fusing agent can be used in the 3D printing system. An example of a 3D printing method is shown in FIG. 2.

The 3D printing method 200 shown in FIG. 2 includes applying a polymeric build material composition to form a build material layer (reference numeral 202); based on a 3D object model, selectively applying an ultraviolet (UV) light fusing agent on at least a portion of the build material layer, the UV light fusing agent, including a UV light absorber consisting of a fluorescent yellow dye and a liquid vehicle including a surfactant, a co-solvent, and a balance of water (reference numeral 204); and exposing the build material layer to UV radiation to coalesce the at least the portion to form a layer of a 3D object (reference numeral 206).

Prior to execution of the method 200, it is to be understood that a controller may access data stored in a data store pertaining to a 3D object that is to be printed. For example, the controller may determine the number of layers of the build material composition that are to be formed, the locations at which any of the agents is/are to be deposited on each of the respective layers, etc.

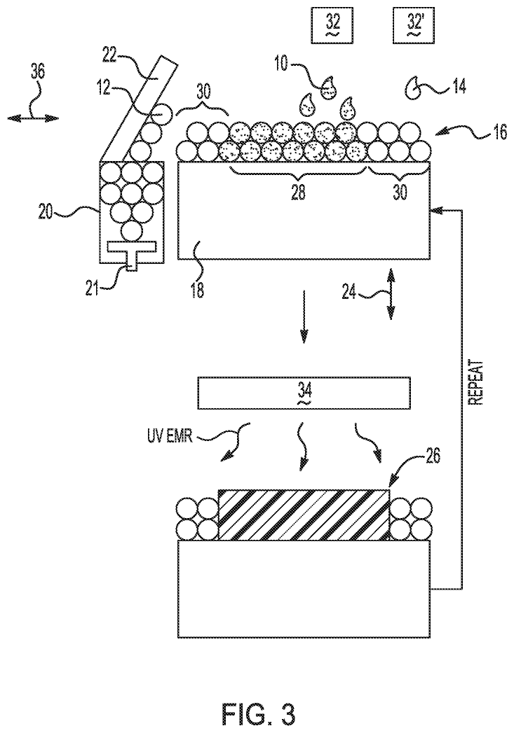

Referring now to FIG. 3, an example of the method 200, which utilizes the fusing agent 10 (including the fluorescent yellow dye)), the build material composition 12, and the detailing agent 14 is graphically depicted.

In FIG. 3, a layer 16 of the build material composition 12 is applied on a build area platform 18. A printing system may be used to apply the build material composition 12. The printing system may include the build area platform 18, a build material supply 20 containing the build material composition 12, and a build material distributor 22.

The build area platform 18 is a substantially horizontal build platform that does not function as a mold for the build material composition 12 applied thereto. Rather, the build area platform is a flat surface upon which the build material composition 12 can be applied and patterned to define any desirable shape. The build area platform 18 may be integrated with the printing system or may be a component that is separately insertable into the printing system. For example, the build area platform 18 may be a module that is available separately from the printing system. The build material platform 18 that is shown is also one example, and could be replaced with another support member, such as a platen, a fabrication/print bed, a glass plate, or another build surface.

The build area platform 18 receives the build material composition 12 from the build material supply 20. The build area platform 18 may be moved in the directions as denoted by the arrow 24, e.g., along the z-axis, so that the build material composition 12 may be delivered to the build area platform 18 or to a previously formed layer. In an example, when the build material composition 12 is to be delivered, the build area platform 18 may be programmed to advance (e.g., downward) enough so that the build material distributor 22 can push, or another dispenser can dispense, the build material composition 12 onto the build area platform 18 to form a substantially uniform layer of the build material composition 12 thereon. The build area platform 18 may also be returned to its original position, for example, when a new part is to be built.

The build material supply 20 may be a container, bed, or other vessel or surface that is to deliver the build material composition 12 into a suitable position for spreading. In one example (not shown in FIG. 3), the build material supply 20 is a remote vessel that feeds the build material composition 12 into a build material dispenser (e.g., a feeder vane) from above through a tube or other conduit. In some instances, the build material supply 20 may be part of the build material dispenser, and thus may translate with the build material dispenser. In this example, the dispenser may be moved in the directions as denoted by the arrow 36, e.g., along the y-axis, over and across the build area platform 18 to spread the layer 16 of the build material composition 12 over the build area platform 18. This enables the build material composition 12 to be delivered continuously to the build area platform 18 rather than being supplied from a single location at the side of the printing system as depicted in FIG. 3. In this example, the build material distributor 22 could also be used to smooth the dispensed layer 16.

In the example shown in FIG. 3, the build material supply 20 includes a mechanism 21 (e.g., a delivery piston or pump) to provide, e.g., move, the build material composition 12 from a storage location to a position to be spread onto the build area platform 18 or onto a previously patterned layer. For example, as shown in FIG. 3, the build material supply 20 may be a stationary container located at the side of the printing system, and its delivery mechanism 21 can push the build material composition 12 into a position where it can be spread across the build area platform 18, e.g., by the build material distributor 22.

The build material distributor 22 may be moved in the directions as denoted by the arrow 36, e.g., along the y-axis, over the build material supply 20 and across the build area platform 18 to spread the layer 16 of the build material composition 12 over the build area platform 18. The build material distributor 22 may also be returned to a position adjacent to the build material supply 20 following the spreading of the build material composition 12. The build material distributor 22 may be a blade (e.g., a doctor blade), a roller, a combination of a roller and a blade, and/or any other device capable of spreading the build material composition 12 over the build area platform 18. For instance, the build material distributor 22 may be a counter-rotating roller.

Any example of the build material supply 20 may include heaters so that the build material composition 12 is heated to a supply temperature ranging from about 25° C. to about 150° C. In these examples, the supply temperature may depend, in part, on the build material composition 12 used and/or the 3D printer used. As such, the range provided is one example, and higher or lower temperatures may be used.

To generate a layer 16 of the build material composition 12, the controller (not shown) may process data, and in response, the build material supply 20 may transmit the build material composition 12 to a dispenser, or may appropriately position the particles of the build material composition 12 for spreading by the build material distributor 22. The controller may also process additional data, and in response, control the build material distributor 22 to spread the build material composition 12 over the build area platform 18 to form the layer 16 of the build material composition 12 thereon. In FIG. 3, one build material layer 16 has been formed.

The layer 16 has a substantially uniform thickness across the build area platform 18. In an example, the build material layer 16 has a thickness ranging from about 50 μm to about 950 μm. In another example, the thickness of the build material layer 16 ranges from about 30 μm to about 300 μm. It is to be understood that thinner or thicker layers may also be used. For example, the thickness of the build material layer 16 may range from about 20 μm to about 500 μm. The layer thickness may be about 2×(i.e., 2 times) the average particle size of the polymer particles at a minimum for finer part definition. In some examples, the layer 16 thickness may be about 1.2× the average particle size of the polymer particles.

After the build material composition 12 has been applied, and prior to further processing, the build material layer 16 may be exposed to pre-heating. In an example, the pre-heating temperature may be below the melting point or melting range of the polymer particles of the build material composition 12. As examples, the pre-heating temperature may range from about 5° C. to about 50° C. below the melting point or the lowest temperature of the softening range of the polymeric material. In an example, the pre-heating temperature ranges from about 50° C. to about 205° C. In still another example, the pre-heating temperature ranges from about 100° C. to about 190° C. It is to be understood that the pre-heating temperature may depend, in part, on the build material composition 12 used. As such, the ranges provided are some examples, and higher or lower temperatures may be used.

Pre-heating the layer 16 may be accomplished by using any suitable heat source that exposes all of the build material composition 12 in the layer 16 to the heat. Examples of the heat source include a thermal heat source (e.g., a heater (not shown) integrated into the build area platform 18 (which may include sidewalls)) or a radiation source 34.

After the layer 16 is formed, and in some instances is pre-heated, the fusing agent 10 is selectively applied on at least some of the build material composition 12 in the layer 16.

To form a layer 26 of a 3D object, at least a portion (e.g., portion 28) of the layer 16 of the build material composition 12 is patterned with the fusing agent 10. The volume of the fusing agent 10 that is applied per unit of the build material composition 12 in the patterned portion 28 may be sufficient to absorb and convert enough UV radiation so that the build material composition 12 in the patterned portion 28 will coalesce/fuse. The volume of the fusing agent 10 that is applied per unit of the build material composition 12 may depend, at least in part, on the UV light absorber used, the UV light absorber loading in the fusing agent 10, and the build material composition 12 used.

Some portion(s) 30 of the build material layer 16 may not be patterned with the fusing agent 10, and thus is/are not to become part of the final 3D object layer 26. However, thermal energy generated during UV radiation exposure may propagate into the surrounding portion(s) 30 that do not have the fusing agent 10 applied thereto. An example of the detailing agent 14 disclosed herein may be selectively applied to the portion(s) 30 of the layer 16. The detailing agent 14 inhibits the propagation of thermal energy, and thus helps to prevent the coalescence of the non-patterned build material portion(s) 30.

After the fusing agent 10 and, in some instances, the detailing agent 14 are selectively applied in the specific portion(s) 28, 30 of the layer 16, the entire layer 16 of the build material composition 12 is exposed to ultraviolet electromagnetic radiation (shown as UV EMR in FIG. 3).

The UV radiation is emitted from the radiation source 34. The length of time the UV radiation is applied for, or energy exposure time, may be dependent, for example, on one or more of: characteristics of the radiation source 34; characteristics of the build material composition 12; and/or characteristics of the fusing agent 10.

It is to be understood that the UV radiation exposure may be accomplished in a single radiation event or in multiple radiation events. In an example, the exposing of the build material composition 12 is accomplished in multiple radiation events. In a specific example, the number of UV radiation events ranges from 3 to 8. In still another specific example, the exposure of the build material composition 12 to electromagnetic radiation may be accomplished in 3 radiation events. It may be desirable to expose the build material composition 12 to UV radiation in multiple radiation events to counteract a cooling effect that may be brought on by the amount of the agent 110, and in some instances the agent 14 that is/are applied to the build material layer 16. Additionally, it may be desirable to expose the polymeric build material composition 12 to UV radiation in multiple radiation events to sufficiently elevate the temperature of the polymeric build material composition 12 in the patterned portion(s) 28, without over heating the build material composition 12 in the non-patterned portion(s) 30.

The UV light absorber (i.e., the fluorescent yellow dye) has a surprisingly efficient temperature boosting capacity, and thus enhances the absorption of the UV radiation, converts the absorbed UV radiation to thermal energy, and promotes the transfer of the thermal heat to the polymeric build material composition 12 in contact therewith. In an example, the fluorescent yellow dye in the fusing agent 10 sufficiently elevates the temperature of the polymeric build material composition 12 in the portion 28 to a temperature at or above the melting point or within the softening range of the polymeric material, allowing coalescing/fusing (e.g., thermal merging, melting, binding, etc.) of the polymeric build material composition 12 to take place. The application of the UV radiation forms the 3D object layer 26, which may have improved color (e.g., reduced yellow, browning) and overall visual quality.

In some examples, the UV radiation has a wavelength ranging from 300 nm to 405 nm, or from 350 nm to 400 nm, or from 360 nm to 380 nm. Radiation having wavelengths within the provided ranges may be absorbed (e.g., 80% or more of the applied radiation is absorbed) by the fluorescent yellow dye in the fusing agent 10 and may heat the polymeric build material composition 12 in contact therewith, and may not be substantially absorbed (e.g., 25% or less of the applied radiation is absorbed) by the non-patterned polymeric build material composition 12 in portion(s) 30.

After the 3D object layer 26 is formed, additional layer(s) may be formed thereon to create an example of the 3D object. To form the next layer, additional polymeric build material composition 12 may be applied on the layer 26. The fusing agent 10 is then selectively applied on at least a portion of the additional build material composition 12, according to the 3D object model. The detailing agent 14 may be applied in any area of the additional build material composition 12 where coalescence is not desirable. After the fusing agent 10, and in some instances the detailing agent 14, is/are applied, the entire layer of the additional polymeric build material composition 12 is exposed to UV radiation in the manner described herein. The application of additional polymeric build material composition 12, the selective application of the agent(s) 12, 14, and the UV radiation exposure may be repeated a predetermined number of cycles to form the final 3D object in accordance with the 3D object model.

As such, examples of the method 200 include iteratively applying the polymeric build material composition 12 to form respective build material layers 16; selectively applying the UV light fusing agent 10 on the respective build material layers 16 to form respective patterned portions 28; and exposing the respective build material layers 16 to UV radiation.

If it is desirable to alter or enhance the color of the 3D object that is being formed, the separate colored ink may also be applied with the fusing agent 10 in the patterned portion(s) 28. The colored ink may be deposited in each layer or in the outermost layers. In this example, the colored ink becomes embedded throughout the coalesced/fused build material composition of the 3D object layers 10. In other examples, the separate colored ink may be applied to the surface of the final 3D object.

In the example method 200, any of the agents (fusing agent 10, detailing agent 14) may be dispensed from an applicator 32, 32′ (shown in FIG. 3). The applicator(s) 32, 32′ may each be a thermal inkjet printhead, a piezoelectric printhead, a continuous inkjet printhead, etc., and the selective application of the fusing agent 10 and detailing agent 14 may be accomplished by thermal inkjet printing, piezo electric inkjet printing, continuous inkjet printing, etc. Other applicators 32, 32′ may be used that can selectively dispense a controlled amount of the agent(s) 12, 14.

The controller may process data, and in response, control the applicator(s) 32, 32′ to deposit the fusing agent 10 and the detailing agent 14 onto predetermined portion(s) of the polymeric build material composition 12. It is to be understood that the applicators 32, 32′ may be separate applicators or a single applicator with several individual cartridges for dispensing the respective agents.

It is to be understood that the selective application of any of the fusing agent 10 and the detailing agent 14 may be accomplished in a single printing pass or in multiple printing passes. In some examples, the agent(s)/formulation(s) is/are selectively applied in a single printing pass. In some other examples, the agent(s) is/are selectively applied in multiple printing passes. In one of these examples, the number of printing passes ranging from 2 to 4. In still other examples, 2 or 4 printing passes are used. It may be desirable to apply the fusing agent 10 in multiple printing passes to increase the amount, e.g., of the UV light absorber, that is applied to the polymeric build material composition 12, to avoid liquid splashing, to avoid displacement of the build material composition 12, etc.

To further illustrate the present disclosure, examples are given herein. It is to be understood that these examples are provided for illustrative purposes and are not to be construed as limiting the scope of the present disclosure.

### EXAMPLES

### Example 1

Solvent Green 7 was used to generate several aqueous formulations having different pH values ranging from 4 to 9. The dye was dissolved in water and the pH was adjusted accordingly using an acid (to achieve pH 4 or 5) or a base (to achieve pH 8 or 9). The absorbance behavior was then measured, and the results are shown in Table 1.

TABLE 1

| | | Peak | |
|---|---|---|---|
| Formulation | | Wavelength | Absorbance |
| ID | PH | (nm) | (AU) |
| 1 | 4 | 403.0 | 0.147 |
| 2 | 5 | 403.0 | 0.151 |
| 3 | 6 | 404.0 | 0.151 |
| 4 | 7 | 404.0 | 0.144 |
| 5 | 8 | 455.0 | 0.107 |
| 6 | 9 | 455.0 | 0.156 |

As depicted, the wavelength of maximum absorption (λₘₐₓ) of Solvent Green 7 can be adjusted by changing the pH. This behavior is desirable as the dye can be incorporated into a jetting fusing agent and its absorbance properties can be tuned for a particular 3D print system.

### Example 2

Two example fusing agents were prepared with Solvent Green 7. One was prepared with an acidic pH (UVFA-A) and the other was prepared with a basic pH (UVFA-B).

The UVFA-A and UVFA-B formulations were compared with two different comparative example formulations, each of which included a different azo dye.

The formulations of the example and comparative fusing agents are shown in Table 2. The weight percentages are shown as active weight percentages.

TABLE 2

| | | | | Comp. | Comp. |
|---|---|---|---|---|---|
| Ingredient | Specific | | | FA | FA |
| Type | Component | UVFA-A | UVFA-B | 1 | 2 |
| Yellow | Solvent | 5.6 | 5.6 | — | — |
| Fluorescent | Green 7 | | | | |
| Dye | | | | | |
| Azo Dye | Acid Yellow | — | — | 4.5 | — |
| | 23 | | | | |
| | Acid Yellow | — | — | — | 6 |
| | 17 | | | | |
| Co-solvent | Propylene | 5 | 5 | 5 | 5 |
| | Glycol | | | | |
| Surfactant | Sodium | 0.9 | 0.9 | 0.9 | 0.9 |
| | Dodecyl | | | | |
| | Sulfate | | | | |
| | SUFYNOL ® | 0.4 | 0.4 | 0.4 | 0.4 |
| | 355 | | | | |
| Base | Potassium | — | <0.01 | — | — |
| | Hydroxide | | | | |
| Water | Deionized | Balance | Balance | Balance | Balance |
| | water | | | | |

| | | | | |
|---|---|---|---|---|
| pH | ~5 | ~9 | ~9 | ~9 |

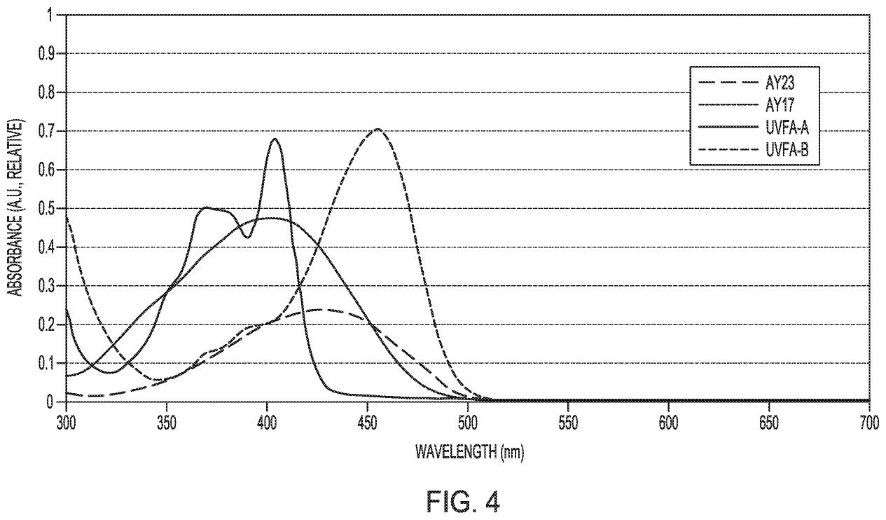

The absorbance behavior was measured, and the results are shown in FIG. 4. Similar to the results shown in Table 1, the acidic fusing agent (UVFA-A) exhibited λₘₐₓ of about 403 nm and the basic fusing agent (UVFA-B) exhibited λₘₐₓ of about 455 nm. The intensity of each of the comparative fusing agents 1 and 2 was lower, and the spectral width of bands was much more spread out (e.g., spreading far into the visible region compared to the acidic fusing agent (UVFA-A)).

### Example 3

The example fusing agent from Example 2, UVFA-A, was used to generate single 3D printed layers. Different agent loadings, power densities, and exposure times were used to compare the fusing efficiency of UVFA-A.

The polymeric build material was polyamide-12. The polyamide-12 build material was spread out into thin layers. The UV light fusing agent was inkjet printed in a rectangular pattern on different build material layers. The fusing agent loading was either 1 drop per pixel or 2 drops per pixel.

The patterned build material layers were maintained at room temperature and were exposed to UV radiation (395 nm, intensity ranging as shown in Table 3) for different times (also shown in Table 3).

TABLE 3

| 3D | UVFA-A | Exposure | Power |
|---|---|---|---|
| Layer | (drop per | Time | Density |
| ID | pixel) | (sec) | (W/cm²) |
| 1 | 1 | 0.5 | 12 |
| 2 | 1 | 1 | 7.2 |
| 3 | 1 | 1 | 9.6 |
| 4 | 1 | 1 | 12 |
| 5 | 2 | 0.4 | 12 |
| 6 | 2 | 0.5 | 12 |
| 7 | 2 | 0.8 | 12 |
| 8 | 2 | 1 | 9.6 |

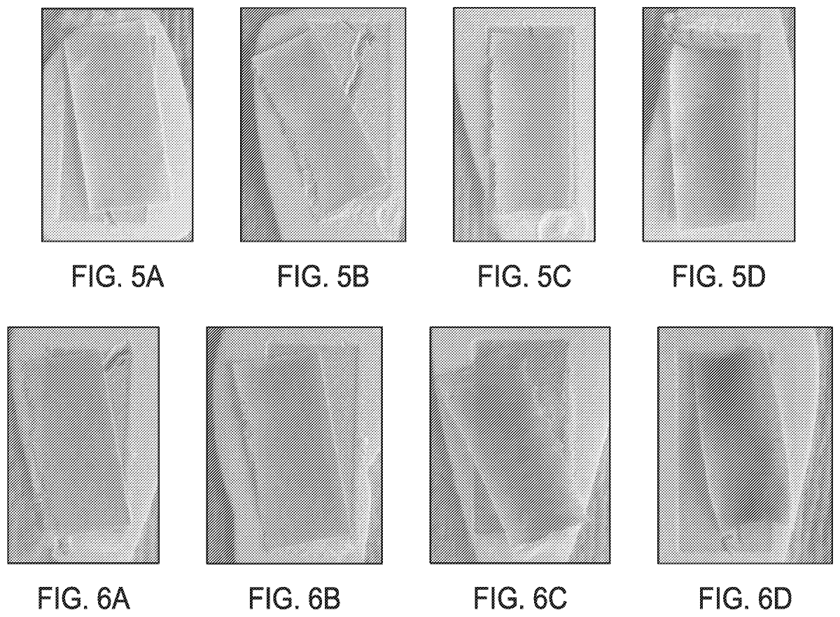

All of the patterned areas formed 3D printed object layers. Photographs were taken of the resulting 3D printed object layers. The photographs of 3D layers 1-4 are shown, respectively in FIG. 5A through FIG. 5D, and the photographs of 3D layers 5-8 are shown, respectively in FIG. 6A through FIG. 6D.

Good fusing was observed across all of the power densities. All of the 3D object layers were able to be handled without breaking. Given that the spectral peaks are at roughly the same intensity for UVFA-A and UVFA-B at their respective peak wavelengths, it can be inferred that the fusing performance of UVFA-B under illumination at 450 nm would be similarly efficient.

As such, the pH-switchability allows Solvent Green 7 (and other like dyes) to be used in either blue (450 nm) or near-UV (395 nm) LED-based fusing systems without sacrificing efficiency and/or spectral match.

The color of the 3D object layers 1, 2, 5 and 7 were a yellow, without much, if any, browning. This indicates that the shorter exposure time combined with higher power density or longer exposure time with lower power density may be the most desirable combination for the 3D printing process.

The overall lower visible absorbance (e.g., compared to carbon black) and the color saturation that the fusing agent provides is desirable.

Additional Notes

It is to be understood that the ranges provided herein include the stated range and any value or sub-range within the stated range, as if such values or sub-ranges were explicitly recited. For example, from about 1 wt % active to about 10 wt % active should be interpreted to include not only the explicitly recited limits of from about 1 wt % active to about 10 wt % active, but also to include individual values, such as about 3.6 wt % active, about 7.75 wt % active, about 8 wt % active, about 9.25 wt % active, etc., and sub-ranges, such as from about 4.5 wt % active to about 8.5 wt % active, from about 4 wt % active to about 6 wt % active, from about 5 wt % active to about 9 wt % active, etc.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein. As an example, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An ultraviolet (UV) light fusing agent for three-dimensional (3D) printing, comprising:
a UV light absorber consisting of a fluorescent yellow dye; and
a liquid vehicle including a surfactant; a co-solvent; and a balance of water;
wherein the UV light fusing agent is devoid of a saccharide.

2. The UV light fusing agent as defined in claim 1, wherein the fluorescent yellow dye is selected from the group consisting of Solvent Green 7, Acid Yellow 184, Acid Yellow 250, Yellow 101, Basic Yellow 40, Solvent Yellow 43, Solvent Yellow 44, Solvent Yellow 85, Solvent Yellow 145, Solvent Yellow 160:1, and combinations thereof.

3. The UV light fusing agent as defined in claim 1, wherein:
the fluorescent yellow dye is Solvent Green 7;
a pH of the UV light fusing agent ranges from about 4 to about 7; and
a wavelength of maximum absorption of the UV light fusing agent ranges from about 403 nm to about 404 nm.

4. The UV light fusing agent as defined in claim 1, further comprising a base.

5. The UV light fusing agent as defined in claim 4, wherein:
the fluorescent yellow dye is Solvent Green 7;
a pH of the UV light fusing agent ranges from about 8 to about 9; and
a wavelength of maximum absorption of the UV light fusing agent is about 455 nm.

6. The UV light fusing agent as defined in claim 1, wherein the UV light fusing agent is devoid of a pigment or an other dye.

7. The UV light fusing agent as defined in claim 1, wherein:
the UV light absorber is present in the UV light fusing agent in an amount ranging from about 2 wt % active to about 10 wt %, based on a total weight of the UV light fusing agent;
the surfactant is present in the UV light fusing agent in an amount ranging from about 0.5 wt % active to about 2 wt % active, based on the total weight of the UV light fusing agent; and
the co-solvent is present in the UV light fusing agent in an amount ranging from about 5 wt % to about 20 wt % active, based on the total weight of the UV light fusing agent.

8. A method for making a UV light fusing agent having a wavelength of maximum absorption targeted for a 3D printing system, comprising:
selecting a pH-switchable fluorescent yellow dye that absorbs at least some ultraviolet wavelengths;
incorporating the pH-switchable fluorescent yellow dye into a liquid vehicle, thereby forming the UV light fusing agent; and
adjusting a pH of the UV light fusing agent to achieve the targeted wavelength of maximum absorption.

9. The method as defined in claim 8, wherein:
the pH-switchable fluorescent yellow dye is Solvent Green 7;
adjusting the pH involves adding a base; and
the targeted wavelength of maximum absorption is about 455 nm.

10. The method as defined in claim 8, wherein:
the pH-switchable fluorescent yellow dye is Solvent Green 7;
the incorporation of the pH-switchable fluorescent yellow dye into the liquid vehicle adjusts the pH to within a range of from about 4 to about 7; and
the targeted wavelength of maximum absorption ranges from about 403 nm to about 404 nm.

11. A multi-fluid kit for three-dimensional (3D) printing, comprising:
an ultraviolet (UV) light fusing agent including:
a UV light absorber consisting of a fluorescent yellow dye; and
a liquid vehicle including a surfactant; a co-solvent; and a balance of water; and
a detailing agent.

12. The multi-fluid kit as defined in claim 11, wherein:
the detailing agent includes a second surfactant; a second co-solvent; and a balance of water; and
the detailing agent is devoid of a colorant.

13. The multi-fluid kit as defined in claim 11, wherein:
the fluorescent yellow dye is selected from the group consisting of Solvent Green 7, Acid Yellow 184, Acid Yellow 250, Yellow 101, Basic Yellow 40, Solvent Yellow 43, Solvent Yellow 44, Solvent Yellow 85, Solvent Yellow 145, Solvent Yellow 160:1, and combinations thereof; and
the UV light fusing agent is devoid of a pigment or an other dye.

14. The multi-fluid kit as defined in claim 11, wherein:
the fluorescent yellow dye is Solvent Green 7;
a pH of the UV light fusing agent ranges from about 4 to about 7; and
a wavelength of maximum absorption of the UV light fusing agent ranges from about 403 nm to about 404 nm.

15. The multi-fluid kit as defined in claim 11, wherein:
the fluorescent yellow dye is Solvent Green 7;
the UV light fusing agent further comprises a base and has a pH ranging from about 8 to about 9; and
a wavelength of maximum absorption of the UV light fusing agent is about 455 nm.
